(19) United States
(12) Patent Application Publication
(10) Pub. No.: US 2026/0227960 A1
(43) Pub. Date: Aug. 6, 2026

(54) SELF-EVOLVING INFRASTRUCTURE USING LLM

(71) Applicant: ORACLE INTERNATIONAL CORPORATION, Redwood Shores, CA (US)

(72) Inventors: Paul Gregory GREENSTEIN, Hopkinton, MA (US); Zbigniew HOLKA, Solihull, (GB)

(21) Appl. No.: 19/046,315

(22) Filed: Feb. 5, 2025

(51) Int. Cl. G06F 8/10; G06F 8/61; G06F 8/65

(52) U.S. Cl. CPC G06F 8/10; G06F 8/61; G06F 8/65

(57) ABSTRACT

Systems, methods, and other embodiments associated with self-evolution of compute infrastructure using LLMs are described. In one embodiment, a method includes monitoring a parameter relating to a compute infrastructure that is deployed to a target computing system for a condition. In response to detection of the condition, the method revises infrastructure requirements for the compute infrastructure to express an adaptation to the condition using a first LLM. The infrastructure requirements are in human language. The method modifies an infrastructure topology for the compute infrastructure to conform to the revised infrastructure requirements using one or more additional LLMs. The method converts the modified infrastructure topology into an executable deployment specification for evolved compute infrastructure that conforms to the revised infrastructure requirements. And, the method executes the deployment specification to install the evolved compute infrastructure on the target computing system to cause the parameter to cease to detect the condition.

### BACKGROUND

Cloud platforms have become popular tools for hosting software applications due to their adaptability, scalability, and accessibility. While the computing environment of a cloud platform is largely virtualized, compute infrastructure deployed in a cloud platform remains static and unresponsive to changes in real-world usage unless manually updated by an administrator.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments one element may be implemented as multiple elements or that multiple elements may be implemented as one element. In some embodiments, an element shown as an internal component of another element may be implemented as an external component and vice versa. Furthermore, elements may not be drawn to scale.

FIG. 1 illustrates one embodiment of an infrastructure evolution system that is associated with self-evolution of compute infrastructure using LLMs.

FIG. 2 illustrates one embodiment of an infrastructure evolution method that is associated with self-evolution of compute infrastructure using LLMs.

FIG. 3 illustrates one example embodiment of an infrastructure evolution process that is associated with self-evolution of compute infrastructure using LLMs.

FIG. 4 illustrates one embodiment of an infrastructure production method that is associated with self-evolution of compute infrastructure using LLMs.

FIG. 5 illustrates one embodiment of an infrastructure modification method that is associated with self-evolution of compute infrastructure using LLMs.

FIG. 6 illustrates an embodiment of a computing system configured with the example systems and/or methods disclosed.

### DETAILED DESCRIPTION

Systems, methods, and other embodiments are described herein that provide self-evolving compute infrastructure using one or more LLMs. In one embodiment, an infrastructure evolution system autonomously adapts a deployed compute infrastructure to conform to monitored conditions. For example, the infrastructure evolution system monitors conditions (such as utilization level of resources of the infrastructure) for changes that affect fulfillment of the infrastructure requirements, and in response to detection of such a change, revises the infrastructure requirements with an LLM, automatically generates an updated infrastructure design from the revised infrastructure requirements, and automatically deploys new infrastructure that implements the updated infrastructure design. In this way, the infrastructure evolution system autonomously evolves to adapt to changing conditions.

In one embodiment, the infrastructure evolution techniques described herein improves the technology of cloud computing by enabling compute infrastructure to autonomously evolve to overcome or avoid proscribed operating conditions autonomously, where this was not previously possible. Moreover, in one embodiment, because the infrastructure evolution techniques described herein use LLMs to revise design requirements and infrastructure topologies, the improvement is generally applicable and is capable of adapting virtualized compute infrastructure to overcome an extremely wide variety of detectable operational problems.

### Definitions

Infrastructure designs may be referred to herein more formally as infrastructure topologies. As used herein, “infrastructure topology” refers to a description of component configuration in a computing system as a graph (or collection of textual tokens translatable to a graph).

As used herein, “Logical Infrastructure Topology” (LIT) refers to a graph (or collection of textual tokens translatable to a graph) that represents an architecture of a system, focusing on the relationships and interactions between different functional elements or components without specifying the actual physical devices or resources involved. In a LIT, the emphasis is on how various components of the system are functionally organized and interconnected, such as the flow of data, communication paths, and the arrangement of software or service components. A LIT serves as a blueprint that outlines logical structure and behavior of the system, independent of the underlying physical infrastructure that will implement it.

As used herein, “Physical Infrastructure Topology” (PIT) refers to a graph (or collection of textual tokens translatable to a graph) that represents the concrete, real-world implementation of a system's architecture, specifying the actual physical devices, resources, and connections that support the logical components described in the LIT. In a PIT the emphasis is on detailing the specific hardware, network configurations, storage solutions, and other physical elements that will be used to realize the system. For example, this may include specifying devices like servers, routers, switches, IP address ranges, and the physical connections between them. A PIT serves as a mapping of the LIT onto actual infrastructure that will be deployed and managed in a data center or cloud environment.

As used herein, “human language” refers to natural, everyday language used by people to communicate, including written text or spoken dictation that is used to express infrastructure requirements for compute infrastructure. Human language includes, but is not limited to, written and typewritten forms of text that are converted into electronic data, spoken dictation that is received by a computing device and converted into electronic data, and text extracted from spoken dictation using voice-to-text conversion and/or speech recognition technology. An item of electronic data (such as a changed infrastructure requirement) is “in human language” where the electronic data expresses, records, defines, stores, or otherwise represents textual (written) or vocal (spoken) human language.

As used herein, the term “infrastructure requirements” refers to a human language description of features or functions of a compute infrastructure. The infrastructure requirements detail what the compute infrastructure is to accomplish. The infrastructure requirements may include functional requirements: requirements that describe what functions, behaviors, actions, or tasks the compute infrastructure is to perform. And, the infrastructure requirements may include non-functional requirements, such performance criteria (such as response time, sustained volume of transactions, pace, etc.), operational constraints (e.g., availability, reliability, disaster recovery), technological constraints (e.g., standards compliance, desired technologies or products), and quality attributes (e.g., maximum tolerable defect rate and maintainability). In one embodiment, functional requirements alone are considered for generation of a LIT. In one embodiment, non-functional requirements may be disregarded during generation of a LIT, and are considered for generation of a PIT.

No action or function described or claimed herein is performed by the human mind. An interpretation that any action or function can be performed in the human mind is inconsistent with and contrary to this disclosure.

### Example Infrastructure Evolution System

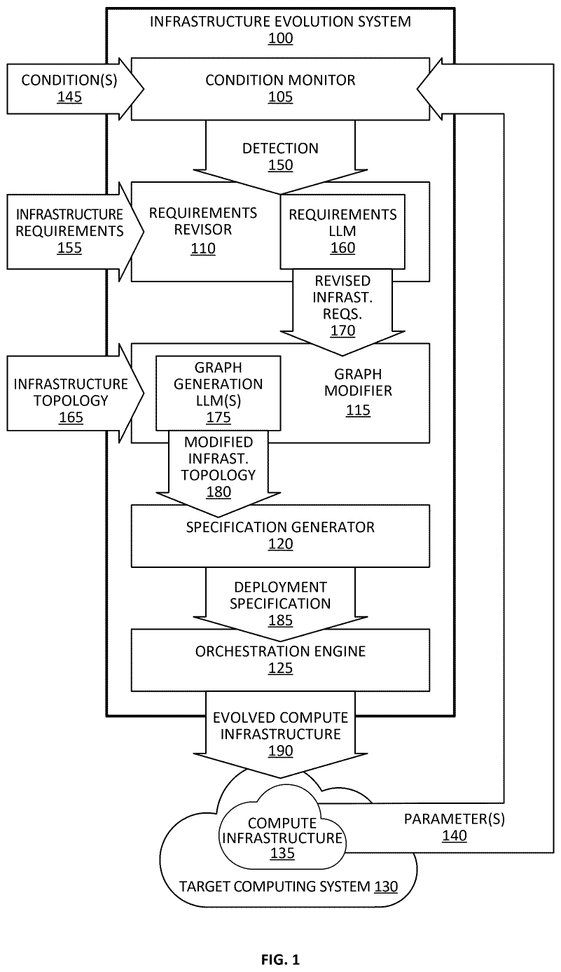

FIG. 1 illustrates one embodiment of an infrastructure evolution system 100 that is associated with self-evolution of compute infrastructure using LLMs. In one embodiment, infrastructure evolution system 100 includes components configured to use LLMs to modify the infrastructure requirements and infrastructure topologies for deployed compute infrastructure to autonomously update or evolve deployed compute infrastructure to adapt to changes in utilization, software versions, or other conditions. Infrastructure evolution system 100 has various components, including a condition monitor 105, a requirements revisor 110, a graph modifier 115, a specification generator 120, and an orchestration engine 125. Infrastructure evolution system 100 may control deployment of compute infrastructure 135 to target computing system 130. And, infrastructure evolution system 100 may monitor one or more parameters 140 with respect to compute infrastructure 135. In one embodiment, the components of infrastructure evolution system 100 and target computing system 130 intercommunicate via a network, for example by electronic messages, as discussed below under the heading “Cloud or Enterprise Embodiments.”

In one embodiment, condition monitor 105 is configured to monitor a parameter 140 relating to a compute infrastructure 135 that is deployed to a target computing system 130 for a condition 145. For example, condition monitor 105 may be configured to continually (at an interval) monitor the parameter 140 for the detection 150 of the condition until an instruction to cease the monitoring is received. The condition is a pre-specified test to determine, based on the parameter 140, whether to proceed to evolve the compute infrastructure, or leave an existing configuration of the compute infrastructure in place.

In one embodiment, requirements revisor 110 is configured to, in response to detection 150 of the condition, revise infrastructure requirements 155 for the compute infrastructure 135 to express an adaptation to the condition 145 using a requirements LLM 160. The infrastructure requirements 155 are in human language. In one embodiment, graph modifier 115 is configured to modify an infrastructure topology 165 for the compute infrastructure 135 to conform to the revised infrastructure requirements 170 using one or more graph generation LLMs 175. In one embodiment, specification generator 120 is configured to convert the modified infrastructure topology 180 into an executable deployment specification 185 for producing an evolved compute infrastructure 190 that conforms to the revised infrastructure requirements. In one embodiment, orchestration engine 125 is configured to execute the deployment specification 185 to install the evolved compute infrastructure 190 on the target computing system 130 that causes the parameter to cease to satisfy the condition.

In one embodiment, target computing system 130 is physical compute infrastructure (i.e., a hardware environment) that is configurable by orchestration engine 125 as specified by an infrastructure topology, such as infrastructure topology 180. For example, target computing system 130 is a cloud computing system. Target computing system 130 includes computing hardware components that inter-operate to provide computing resources. For example, target computing system 130 includes one or more bare metal computer servers (which include physical processors, memory, and non-transitory computer-readable storage media) interconnected by a physical data network. Target computing system 130 is configured to host physical compute infrastructure, including virtual machines, networks and subnetworks, databases and other storage, load balancers, bastions, gateways, firewalls, or other infrastructure components. Such compute infrastructure components may be provisioned atop the underlying bare metal hardware of target computing system 130.

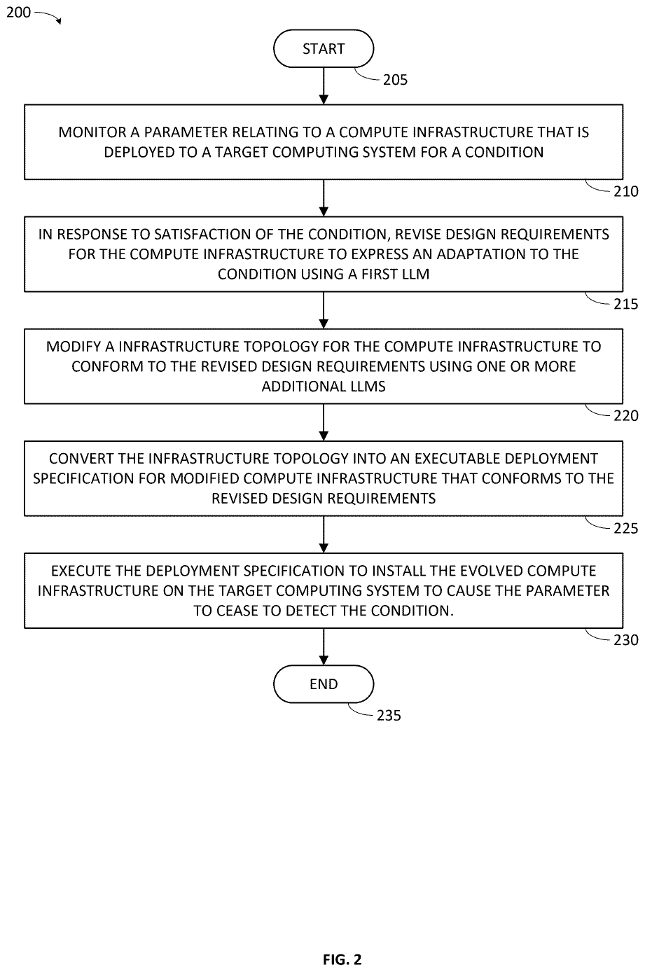

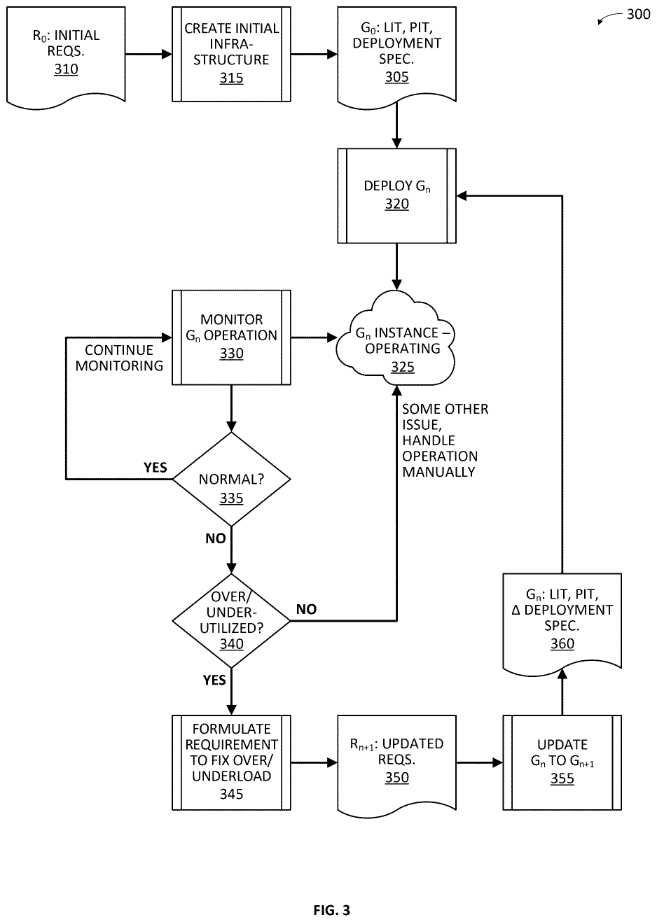

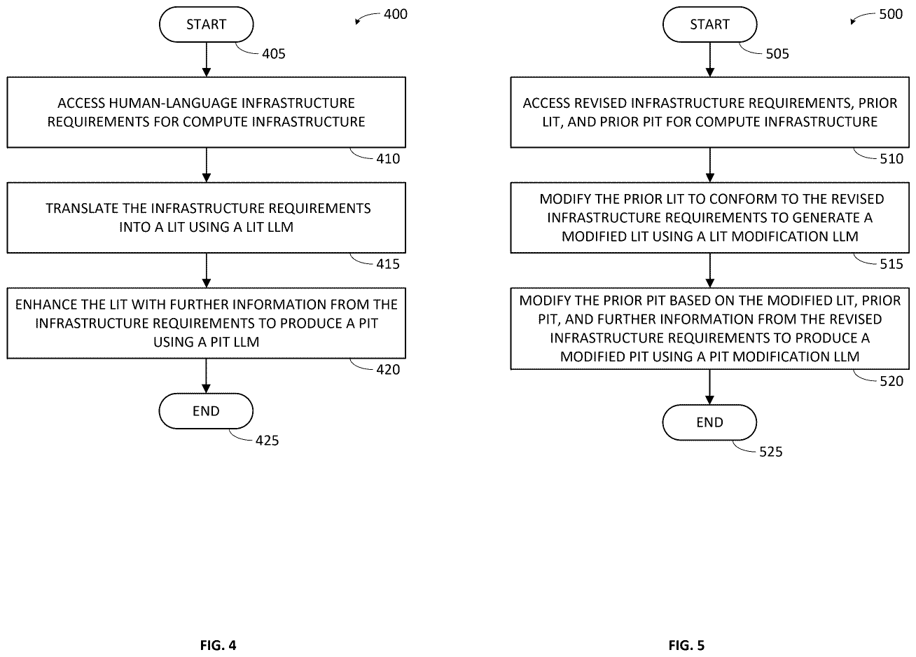

Further details regarding infrastructure evolution system 100 are presented herein. In one embodiment, operations of infrastructure evolution system 100 will be described with reference to infrastructure evolution method 200 of FIG. 2. and example infrastructure evolution process 300 of FIG. 3. In one embodiment, additional detail regarding initial automated generation of compute infrastructure will be described with reference to infrastructure production method 400 of FIG. 4. In one embodiment, additional detail regarding automated modification of compute infrastructure will be described with reference to infrastructure modification method 500 of FIG. 5.

### Example Infrastructure Evolution Method

FIG. 2 illustrates one embodiment of an infrastructure evolution method 200 that is associated with self-evolution of compute infrastructure using LLMs. In one embodiment, as a general overview, infrastructure evolution method 200 detects when a change in operational circumstances indicates that compute infrastructure should be adjusted, and then, using LLMs, autonomously configures and deploys evolved compute infrastructure that is adapted to the changed operational circumstances.

For example, the infrastructure evolution method 200 monitors compute infrastructure that has been deployed to a target computing system to detect whether a change to the infrastructure is indicated, for example by checking one or more parameters related to the compute infrastructure for detection of one or more conditions. Where the infrastructure evolution method 200 determines to change the infrastructure, the infrastructure evolution method 200 uses a requirements LLM to change human language infrastructure requirements for the compute infrastructure. Then, using one or more LLMs configured to generate infrastructure topologies in a graph representation language, the infrastructure evolution method 200 generates an infrastructure topology for an arrangement of the compute infrastructure that has evolved to satisfy the revised infrastructure requirements. The infrastructure evolution method 200 parses the infrastructure topology to convert the infrastructure topology into executable instructions for configuring the target computing system to have the evolved infrastructure. The infrastructure evolution method 200 then executes the instructions to effect the evolution of the infrastructure in the target environment.

In other words, the infrastructure evolution system 100 keeps an eye on a specific aspect of a computer infrastructure set up on a target system to see if a certain condition occurs. When this condition is noticed, the system uses a LLM to update the design requirements of the infrastructure to deal with this condition. These requirements are written in human language, rather than as structured data formatted for consumption by a computer. Then, the infrastructure evolution system 100 uses one or more additional LLMs to adjust the structure of the infrastructure to match the updated requirements. Next, the infrastructure evolution system 100 turns these adjustments into a set of instructions that can be executed to update the infrastructure. Finally, the infrastructure evolution system 100 carries out these instructions to replace the old infrastructure with the new, updated one on the target system, ensuring that the originally monitored condition is resolved.

In one embodiment, infrastructure evolution method 200 initiates at START block 205 in response to infrastructure evolution system 100 determining that one or more conditions or events have been detected or have occurred. The conditions or events for initiating infrastructure evolution method 200, include, but are not limited to: (1) infrastructure evolution system 100 has received an instruction to commence infrastructure evolution method 200; (2) infrastructure evolution system 100 has received a change to a value of a parameter that is monitored for adaptation of compute infrastructure; (3) a user or administrator has initiated infrastructure evolution method 200; (4) it is currently a time at which infrastructure evolution method 200 is scheduled to be run; or (5) some other condition for commencing infrastructure evolution method 200 has been satisfied. As used herein, the use of the term “in response to” an event indicates that an action or task is automatically initiated, carried out, completed, or otherwise performed automatically upon the occurrence of the event.

In one embodiment, a computing system configured by computer-executable instructions to execute functions of infrastructure evolution system 100 executes infrastructure evolution method 200 (or other methods described herein). In one embodiment, at START block 205, infrastructure evolution system 100 configures compute resources for performing infrastructure evolution method 200. (1) infrastructure evolution system 100 provisions (i.e., allocates and initializes) resources of the computing system that are used by infrastructure evolution system 100, such as processor, memory and storage (for example, for executing components of infrastructure evolution system 100). (2) infrastructure evolution system 100 establishes access to one or more networks for the resources, such as access to (a) internal networks for communication among components of infrastructure evolution system 100 and (b) external networks for communication with other computing systems (for example, client systems or target computing system 130). (3) infrastructure evolution system 100 connects to data sources (such as databases, data stores, file systems, and cloud storage) used by the infrastructure evolution method 200. And, (4) infrastructure evolution system 100 configures the computing system with system settings, software dependencies and libraries, and modules for executing the components of infrastructure evolution system 100. Following initiation at START block 205, infrastructure evolution method 200 proceeds to block 210.

At block 210, infrastructure evolution method 200 monitors a parameter relating to a compute infrastructure that is deployed to a target computing system for a condition. In other words, infrastructure evolution method operates to observe or track operational metrics of a deployed compute infrastructure to detect the occurrence of pre-defined or pre-specified conditions. The monitoring here acts as a trigger to commence an evolution of the infrastructure when the parameter meets a specific threshold. For example, infrastructure evolution method 200 is provided with a pre-specified condition for initiating an evolution of the infrastructure, and monitors the parameters to determine whether the pre-specified condition is satisfied. In one embodiment, infrastructure evolution method 200 commences an evolution of the infrastructure based on a trigger from monitoring, news of a particular product or technology update, or other similar change to a parameter value.

In one embodiment, the infrastructure evolution method 200 performs a continual (including both continuous and interval-based) condition monitoring. The condition monitoring may use sensors or software tools to collect data relating to the operation of the compute infrastructure in the target computing system. The sensors and/or software tools report metrics back to the condition monitor 105. The metrics include one or more parameters 140 that describe resource utilization, system performance, or other metrics included in evaluation of the condition 145.

In one embodiment, the infrastructure evolution method 200 uses sensors or monitoring agents installed on the target computing system (or other sources) to collect values of specific parameters. The parameter values may be real-time data read from the various sources. The parameter data may be collected from various points within and outside of the compute infrastructure and target system. In one embodiment, the parameters may be obtained from a telemetry system that is configured to monitor the target computing system and/or the compute infrastructure deployed to the target computing system. The telemetry system is discussed in further detail under the heading “Telemetry” below.

The parameters could include CPU usage, memory utilization, network traffic, application performance metrics, or other quantifiable information about the operation of the compute infrastructure in the target computing system. Such parameters may indicate a level of usage of the compute infrastructure that is deployed to the target computing system.

The monitoring agents may also monitor news or data feeds to determine values of parameters. For example, the monitoring agents may watch for availability of updates to components of the compute infrastructure, such as new versions or patches, and generate parameter values indicating whether the compute infrastructure deployed to the target computing system is up to date.

In one embodiment, the condition 145 is configured to be determinative of whether the infrastructure should evolve or not. A threshold for detection of the condition 145 may be expressed in a Boolean expression. One or more of the parameter values are the input variables to the threshold. There may be multiple conditions and associated thresholds.

In one embodiment, the monitoring of the parameter by the infrastructure evolution method 200 might be configured to detect either (i) a severe and prolonged underutilization of resources within the operating infrastructure instance, or (ii) a severe and prolonged overutilization of resources within the compute infrastructure instance. For example, a threshold may be that CPU usage is above a pre-specified amount (e.g., 95%), sustained over a pre-specified amount of time (e.g., 600 sec.), which if TRUE, will trigger adjustment of the requirements to increase processing capacity of the compute infrastructure. Thus, in one embodiment, the monitoring of the parameter by the infrastructure evolution method 200 is configured to detect the condition because the compute infrastructure (which is deployed to the target computer system) is overutilized or underutilized based on the parameter.

In one embodiment, the condition resulting in infrastructure evolution may be not prolonged but frequent overutilization of resources, e.g., frequent but short peaks of CPU utilization.

In one embodiment, the condition monitor 105 has a parameter which allows operators to stop detection 150 for predefined time period (blackout), which allows to carry on maintenance on the target computing system 130.

In one embodiment, the monitoring of the parameter by the infrastructure evolution method 200 might be configured to detect when upgrades to software components of the compute infrastructure become available. For example, a threshold may be that a more recent security patch to an operating system (of one or more virtual machines in the deployed compute infrastructure) has become available, which if TRUE, will trigger adjustment of the requirements to specify the patched version of the operating system. Thus, in one embodiment, the monitoring of the parameter by the infrastructure evolution method 200 is configured to detect that the condition because an update to a component of the target computing system (including components of the compute infrastructure that is deployed to the target computing system) has become available.

In one embodiment, the condition 145 is pre-configured to specify the situation under which the infrastructure is to evolve. For example, the condition 145 may be pre-configured by a user or administrator. At runtime, the infrastructure evolution method 200 may load the condition 145 from a designated location in storage or memory.

In one embodiment, the infrastructure evolution method 200 performs the monitoring continually (allowing for breaks or interruptions) to determine the status of the parameter repeatedly, for example recurring at an interval. The intervals may differ from parameter to parameter, with parameters that are subject to more rapid or frequent change sampled at shorter intervals, and parameters that are subject to slower or less frequent change sampled at longer intervals. In one embodiment, the monitoring ceases upon receipt of an instruction to terminate the monitoring, which may occur for example when a user or administrator enters a command to shut down or pause infrastructure evolution method 200.

In one embodiment, the infrastructure evolution method 200 determines whether the condition is detected. When the Boolean expression for detection of the condition is satisfied (TRUE), the infrastructure evolution method 200 enters a loop through blocks 215, 220, 225, and 230 to autonomously evolve or update the compute infrastructure in the target computing system. Once the compute infrastructure has been adjusted, the infrastructure evolution method 200 returns to the monitoring at block 210. When the Boolean expression for detection of the condition is not satisfied (FALSE), infrastructure evolution method 200 remains in the monitoring step of block 210. The detection may be performed by a periodic evaluation of the condition to determine whether current parameter(s) values cause the Boolean expression for detection of the condition to be satisfied.

In one embodiment, the condition resulting in an evolutionary change, may be predictive and resulting in a proactive or anticipatory evolutionary change. E.g., the condition may involve observing a particular measurement over time, extrapolating a future value or state related to the infrastructure, determining that a future value or state requires a change in the infrastructure, and enacting an evolutionary change proactively, in advance of reaching a particular value or state.

In one embodiment, infrastructure evolution method 200 monitors a parameter relating to a compute infrastructure that is deployed to a target computing system for a condition by performing the following general steps. The infrastructure evolution method 200 defines which parameters of the compute infrastructure are to be monitored, for example by loading the pre-defined condition(s) and extracting the parameter(s) to be monitored. The infrastructure evolution method 200 accesses monitoring agent, sensors, and newsfeeds to collect current values of the parameters, for example as a stream of values of the parameters, or as an alert when a parameter value changes. The infrastructure evolution method 200 continually collects the values of the parameters from the target system or other sources, for example at predefined intervals or in real time. The infrastructure evolution method 200 continually evaluates the Boolean expression for detection of the condition using current value(s) for the parameter(s), for example using a rules engine, to check whether the condition is met. Where the condition is detected, infrastructure evolution method 200 generates an electronic alert that autonomously launches subsequent steps to evolve or update the compute infrastructure.

In one embodiment, the steps of block 210 are performed by condition monitor 105. At the conclusion of block 210, infrastructure evolution method 200 has determined whether a condition is present that indicates that adjustment of the compute infrastructure should proceed. Thus, when the process that uses the compute infrastructure begins to show signs of outgrowing the compute infrastructure (or of being over provisioned with excessive resource allocations), the infrastructure evolution method 200 has decided whether to modify the compute infrastructure. Processing continues to block 215.

In one embodiment, the electronic alert that triggers the subsequent steps to evolve the compute infrastructure is presented to a user or administrator for confirmation before proceeding. For example, the electronic alert may be displayed in a user interface that prompts an administrator to accept or cancel proceeding with the autonomous evolution of the compute infrastructure. Upon receiving an input indicating acceptance, the infrastructure evolution method 200 proceeds to revise infrastructure requirements for the compute infrastructure at block 215.

At block 215, infrastructure evolution method 200, in response to detection of the condition, revises infrastructure requirements for the compute infrastructure to express an adaptation to the condition using a first LLM. The infrastructure requirements are in human language. Once a predefined condition is detected (e.g., excessive resource consumption), the requirements revisor 110 initiates a process to adjust the design requirements. In this step, infrastructure evolution method 200 uses an LLM to modify or update infrastructure specifications to address the operational issues detected by detection of the condition.

In one embodiment, infrastructure evolution method 200 employs natural language processing techniques to interpret human language expressions of infrastructure requirements 155 and modify them to adapt to a changed operational situation. For example, a requirements LLM—which is a large language model that is configured to generate or adjust the natural language of the infrastructure requirements 155—processes the current infrastructure requirements 155 and adapts them based on the condition(s) detected to be occurring during the monitoring. The adaptation modifies the infrastructure requirements 155 to produce revised infrastructure requirements 170.

Where the human language of infrastructure requirements 155 or revised infrastructure requirements 170 is written, the infrastructure requirements may be stored as electronic data in a data structure capable of storing human language text, such as a text file, Word document file, PDF file, and so on. Where the human language of infrastructure requirements 155 or revised infrastructure requirements 170 is spoken, the infrastructure requirements may be stored as electronic data in a data structure capable of storing human language dictation or speech, such as an audio or audio-video file in one of many formats such as MP3 (MPEG-1 Audio Layer III), WAV (Waveform Audio File Format), AAC (Advanced Audio Coding), AIFF (Audio Interchange File Format), OGG (Ogg Vorbis), MP4 (MPEG-4 Part 14), AVI (Audio Video Interleave), MKV (Matroska Video File), other MPEG formats, and so on.

The existing infrastructure requirements 155 correspond to and specify the compute infrastructure 135 that is currently deployed to the target computing system 130. The requirements LLM edits the infrastructure requirements 155 to address a change in the operational situation. For example, the requirements LLM generates revised infrastructure requirements 170, articulated in human language, that reflect new requirements, changes, or optimizations to correct for the condition(s). The requirements LLM processes the existing infrastructure requirements 155 and integrates changes to address the detected condition, thereby producing the revised infrastructure requirements 170. The revised infrastructure requirements 170 are generated in human-readable language, ensuring they can be reviewed by engineers if needed, or directly used by automated systems of the infrastructure evolution system 100.

Infrastructure requirements 155 are in human language. Infrastructure requirements 155 specify the features and functions of a compute infrastructure that has previously been created and/or deployed to the target computing system 130. Infrastructure requirements 155 may be provided as inputs to the infrastructure evolution system 100, or may be accessed by infrastructure evolution system 100 from a location in storage.

Revised infrastructure requirements 170 are in human language. Revised infrastructure requirements 170 specify features and functions of compute infrastructure that correct for proscribed operational states (such as overutilization, underutilization, or outdated software versions) of compute infrastructure 135 that is currently deployed to the target computing system 130. Revised infrastructure requirements 170 are generated from infrastructure requirements 155 and condition(s) triggered by parameter values at block 210.

The generation of revised infrastructure requirements 170 from existing infrastructure requirements 155 may be initiated by submitting a prompt to the requirements LLM 160. The prompt may be configured to cause requirements LLM 160 to generate revised infrastructure requirements 170 based on the existing infrastructure requirements and the detected condition(s). The prompt may be dynamically generated, for example by populating a template prompt.

The operational condition of the computer infrastructure that was detected may be associated with a natural language description of the detected operational condition, and a goal of the revision for correcting the operational condition. These descriptions may be dynamically included in the prompt based on which condition(s) were detected. Thus, the template prompt may include variables for: (1) the prior/existing infrastructure requirements 155; (2) a description of the operational condition that has been detected; and (3) a goal or objective of the revision. For example, the template prompt for requirements modification may be something like:
“Given the current design requirements of the compute infrastructure, which are provided below, and in response to the recent detection of [Detected_Operational_Condition], please formulate revised design requirements. The goal for these revisions is to [Goal_of_Revision]. Ensure that the revised requirements address the detected condition effectively while adhering to the original intents where applicable.
Current design requirements are as follows:
[Existing_Design_Requirements]”

In one embodiment, a condition, description of the condition, and corrective goal are associated in a data structure, such as a row of a table of conditions, descriptions, and goals. In one embodiment, the row may also include the Boolean expression for detection of the condition. For example, one operational condition that may be detected could be a bottleneck condition. The bottleneck condition may be detected when Current_Network_Load>Maximum_Network_Bandwidth*Threshold_Percentage_For_Bottleneck is TRUE. The description of the bottleneck condition may be “increased load leading to bandwidth bottlenecks.” And, the corrective goal may be “increase maximum network bandwidth to bring peak load within the threshold percentage for bottleneck.”

When current parameter values cause the Boolean expression for detection of the condition to be TRUE, infrastructure evolution method 200 accesses the description and goal associated with the condition, and inserts the description and goal into the template prompt. Thus, for example, the template prompt for requirements modification might read (in part), “ . . . in response to the recent detection of increased load leading to bandwidth bottlenecks, please formulate revised design requirements. The goal for these revisions is to increase maximum network bandwidth to bring peak load within the threshold percentage for bottleneck . . . ” In one embodiment, the template prompt may be configured to be populated with descriptions and goals for a plurality of detected conditions.

In one embodiment, the template prompt for requirements modification may further include a variable for providing additional constraints and priorities to the revision LLM. Constraints (such as downtime tolerances, technology compatibility, scalability, etc.) as well as priorities (such as a preference for performance enhancement over cost savings, etc.) may be pre-specified by a user or administrator. A description of the pre-specified constraint or priority may be included in the template prompt. For example, the template prompt for requirements modification may include an additional line such as “To the extent possible, prioritize [Description_of_Priority] when making the revisions.”

In one embodiment, requirements LLM 160 may be trained on example training data, industry standards, and/or operational feedback to propose changes to infrastructure requirements. Requirements LLM 160 is configured to process the existing infrastructure requirements 155 and integrate changes to address the detected condition into the infrastructure requirements 155. In this manner, requirements LLM 160 is configured to produce the revised infrastructure requirements 170 based on the infrastructure requirements 155 and the detection 150 of the operational condition.

The infrastructure evolution method 200 submits the populated template prompt to requirements LLM 160. The requirements LLM analyzes the prompt, applying learned rules and patterns to propose changes to the natural language of the infrastructure requirements. The requirements LLM 160 formulates new requirements based on the condition description, goals, and/or the priorities and constraints. The requirements LLM 160, integrates the newly formulated requirements into the infrastructure requirements 155 by adding, deleting, or altering the text of the infrastructure requirements 155. The requirements LLM 160 returns a response. The response of the requirements LLM 160 includes the revised infrastructure requirements 170. The infrastructure evolution method 200 parses the response to extract the revised infrastructure requirements 170. The infrastructure evolution method 200 stores the extracted revised infrastructure requirements 170 for subsequent processing.

In one embodiment, in response to detection of the condition, revise infrastructure requirements for the compute infrastructure to express an adaptation to the condition using a first LLM, wherein the infrastructure requirements are in human language, as follows. Infrastructure evolution method 200 accesses the infrastructure requirements 155, description of the condition detected in block 210, goal for correcting the condition, and template prompt for requirement revision. Infrastructure evolution method 200 populates the template prompt with the infrastructure requirements 155, the description, and the goal. Infrastructure evolution method 200 submits the populated prompt to a requirements LLM. Infrastructure evolution method 200 executes the requirements LLM to generate a response that includes revised infrastructure requirements 170. The infrastructure evolution method 200 captures the response, extracts the revised infrastructure requirements 170, and stores the revised infrastructure requirements for further use.

In one embodiment, the steps of block 215 are performed by requirements revisor 110. At the conclusion of block 215, infrastructure evolution method 200 has autonomously revised the infrastructure requirements to accommodate or correct for an operational condition that occurs in compute infrastructure that follows the prior infrastructure requirements. An updated infrastructure topology that is not subject to the operational condition is enabled to be created using the revised infrastructure requirements, as discussed below. Processing continues to block 220.

At block 220, infrastructure evolution method 200 modifies an infrastructure topology 165 for the compute infrastructure 135 to conform to the revised infrastructure requirements 170 using one or more additional LLMs (such as graph generation LLM(s) 175). The modification of the infrastructure topology 165 by the LLMs results in a modified infrastructure topology 180. For example, the infrastructure evolution method 200 feeds the infrastructure topology 165 and the revised infrastructure requirements 170 into the graph generation LLM(s) 175 to cause the graph generation LLM(s) 175 to integrate alterations from the revised infrastructure requirements 170 into the infrastructure topology 165. This integration of revisions into the infrastructure topology 165 produces the modified infrastructure topology 180.

The graph generation LLM(s) 175 operate (1) to retain parts of the infrastructure topology 165 that are unaffected by the changes contained in the revised infrastructure requirements 170, and (2) to update parts of the infrastructure topology 165 that are affected by the changes contained in the revised infrastructure requirements 170. The graph generation LLM(s) 175 apply the changes to the infrastructure topology 165 while reusing or keeping sections of the infrastructure topology 165 that are unaffected by the changes. Additional detail regarding LLM-based modification of the infrastructure topology 165 is described below under the heading “Example Infrastructure Modification.”

In one embodiment, the graph generation LLM(s) 175 have been trained to adjust the infrastructure topology 165 to conform to the revised infrastructure requirements 170 while satisfying one or more objective or “goal” criteria. For example, the LLM may be trained to generate a modified graph that satisfies an objective criterion of making “as few changes to the infrastructure topology 165 as possible.” The objective criterion may vary. Example objective criteria include, but are not limited to minimum topology difference, minimum node difference (allowing any edge difference), minimum edge difference (allowing any node difference), minimum cost (or TCO (total cost of ownership), if pertinent to computing infrastructure) per cost attribution based on node and edge types, etc. Various objective criteria may be presented in a user interface for selection when initiating a modification of an infrastructure topology 165.

In one embodiment, infrastructure evolution method 200 provides the infrastructure topology 165 and revised infrastructure requirements 170 to a graph generation LLM 175 in a prompt. The prompt is configured to cause graph generation LLM 175 to generate modified infrastructure topology 180. In one embodiment, infrastructure evolution method 200 dynamically generates a prompt for generation of modified infrastructure topology 180 from the revised infrastructure requirements 170 and the infrastructure topology 165. Infrastructure evolution method 200 submits the prompt to graph generation LLM 175.

In one embodiment, infrastructure topologies may be expressed or encoded in a text-based graph representation language (GRL), rendering the infrastructure graphs amenable to processing and generation by an LLM. Various GRLs may be appropriate for encoding an infrastructure graph, including but not limited to: JSON-Graph, graph modeling language (GML), GraphML, Graphviz DOT, trivial graph format (TGF), and resource description framework (RDF).

In one embodiment, the prompt for generation of the modified infrastructure topology 180 is dynamically generated by loading and populating a template prompt that is configured to initiate graph modification by graph generation LLM 175. The template prompt is a pre-defined text structure that includes placeholders for variables that are populated with values at runtime. The template prompt serves as a blueprint for creating consistent, standardized inputs that are tailored to the task of graph modification.

In one embodiment, the template prompt for graph modification includes the following variables: (i) revised infrastructure requirements 170 (expressed as human language text), (ii) infrastructure topology 165 (expressed in GRL), (iii) a selection of the GRL to be used for the output modified graph; and (iv) a selection of the objective criterion. The template prompt for graph modification includes instructions to generate a modified infrastructure topology 180 in the GRL from the changed infrastructure requirements 135 and the prior infrastructure topology 165. For example, the template prompt for graph modification may be something like:
“Given the existing infrastructure topology graph and the revised infrastructure requirements below, generate a modified physical infrastructure topology in [Graph_Representation_Language] that conforms to the revised infrastructure requirements, while obeying the following criterion [Objective_Criterion].
Infrastructure topology graph:
[Infrastructure_Topology]
Revised infrastructure requirements are as follows:
[Revised_Infrastructure_Requirements]”
Infrastructure evolution method 200 submits the populated prompt for generation of the modified infrastructure topology 180 to the graph generation LLM 175. For example, infrastructure evolution method 200 makes a call to an application programming interface (API) endpoint of the graph generation LLM 175: the prompt is placed in the payload of a request, along with any additional parameters such as model selection, temperature (randomness), maximum number of tokens, etc.; and the request is passed (e.g., by HTTP POST) to the API endpoint of the graph generation LLM 175.

Infrastructure evolution method 200 then captures the modified infrastructure topology 180 that is provided by graph generation LLM 175 in response to the prompt. In one embodiment, infrastructure evolution method 200 parses the response of the LLM to extract the modified graph from other content of the response. For example, the infrastructure evolution method 200 may parse the response to retain content written in GRL and discard other content of the response. Infrastructure evolution method 200 stores the extracted content for subsequent processing.

In one embodiment, more generally, infrastructure evolution method 200 modifies an infrastructure topology 165 for the compute infrastructure 135 to conform to the revised infrastructure requirements 170 using one or more additional LLMs as follows. Infrastructure evolution method 200 (i) dynamically generates a prompt containing the existing infrastructure topology 165 expressed in a GRL, the revised infrastructure requirements 170 expressed as human readable text, a specification of the GRL to be used for the output, and a selection of the objective criterion; (ii) making an API call to graph generation LLM 175 that delivers the prompt as a payload; (iii) generating the modified infrastructure topology 180 using graph generation LLM 175; (iv) capturing the resulting modified infrastructure topology 180 returned by the graph generation LLM 175; and (v) storing the modified infrastructure topology 180 for subsequent use.

In one embodiment, the steps of block 220 are performed by graph modifier 115. At the conclusion of block 220, infrastructure evolution method 200 has generated a modified infrastructure topology 180 that represents the physical implementation of a virtualized architecture for an evolved or updated compute infrastructure. This modified infrastructure topology 180 includes sufficient information to specify and deploy an evolved compute infrastructure 190. Processing continues to block 225.

At block 225, infrastructure evolution method 200 converts the modified infrastructure topology 180 into an executable deployment specification 185 for evolved compute infrastructure 190 that conforms to the revised infrastructure requirements 170. In other words, infrastructure evolution method 200 creates actionable deployment commands in a pre-specified configuration language (such as HCL or YAML) from the modified infrastructure topology 180. Infrastructure evolution method 200 produces deployment instructions for implementing an evolved instance of the compute infrastructure that follows the specifications given in the revised infrastructure requirements 170.

Where the modified infrastructure topology 180 is a LIT, the infrastructure evolution method 200 converts the modified infrastructure topology 180 from a LIT to a PIT (for example as discussed in further detail below with reference to blocks 420 and 520) as a preliminary, intermediate step to generation of the deployment specification 185. Where the modified infrastructure topology 180 is a PIT, the infrastructure evolution method 200 converts the modified infrastructure topology 180 directly into a deployment specification 185.

In one embodiment, infrastructure evolution method 200 may execute a script or other tool that is configured to map the components of an infrastructure topology (e.g., a PIT) to a syntax of the deployment specification 185 (such as YAML or HCL). Infrastructure modification method 500 thus automates adaptation of the modified infrastructure topology 180 to an executable configuration or executable setup tasks. Infrastructure evolution method 200 translates the modified infrastructure topology 180 into a set of instructions—deployment specification 185—that can be autonomously carried out by a computer to set up and deploy the compute infrastructure 135 described in the revised infrastructure requirements 170.

In one embodiment, the tool for conversion of the infrastructure topology to the deployment specification 185 may be an IaC (infrastructure-as-code) specification generator 120. At a high level, operation of the IaC specification generator 120 varies based on the destination tool. For example, to convert a PIT to a YAML Ansible playbook, the IaC specification generator 120 maps the components of the PIT to YAML syntax for tasks and roles that are executable by Ansible. Or, for example, to convert the PIT to an HCL Terraform configuration file, the IaC specification generator 120 maps the components of the PIT graph to HCL syntax for declarative provisioning that is executable by Terraform. IaC specification generator 120 may also generate executable deployment specification files for other orchestration systems, such as Puppet manifest files, Chef recipe and cookbook files, SaltStack states, AWS (Amazon Web Services) Cloud Formation templates, Microsoft Azure Resource Manager (ARM) templates, Google Cloud Deployment Manager Configuration files, Kubernetes manifests, and Docker Swarm compose files.

In one embodiment, infrastructure evolution method 200 operates an IaC specification generator to convert the PIT into an executable deployment specification. The infrastructure evolution method 200 receives and parses the input PIT to identify components of the topology. The parsing recognizes the components based on predefined attributes associated with components. Attributes of components are specific characteristics or properties associated with individual components in the topology that provide details about the component such as type, size, location, or function of the component within the compute infrastructure. Examples of attributes include type of a component (e.g., bastion, load balancer, compute instance, database, subnet, gateway, etc.), unique identifier or other resource name given to a component, and configuration details that are related to a component.

When parsing the PIT, infrastructure evolution method 200 examines the graph elements for attributes that identify what a component is and how it is connected. Infrastructure evolution method 200 recognizes components by matching attributes using a predefined schema or set of rules to match attributes to pre-defined component types. For example, a component with attributes such as “type: virtual_machine” and “cpu_count: 4” would be recognized as a virtual machine (compute instance) that is to be added to the deployment specification. And, for example, a component with attributes such as “type: network” and an “ip_range” would be recognized as a network or sub-network that is to be configured by the deployment specification. Such recognition may be performed by evaluating regular expressions, or other Boolean matching. In this way, based on recognition of attributes, infrastructure evolution method 200 can classify the components that correspond to specific resource types in the deployment specification.

Once the components of the PIT are classified by type, infrastructure evolution method 200 assembles the deployment specification. The deployment specification is written in infrastructure code (e.g., HCL or YAML code), which is used to define and automate deployment of infrastructure. In one embodiment, infrastructure evolution method 200 generates configuration blocks of infrastructure code for each component. In one embodiment, the infrastructure code declaratively defines the compute infrastructure that is to be created by execution of the infrastructure code, as is the case with HCL. In one embodiment, the infrastructure code specifies the steps to be performed by execution of the code which will result in creation of the compute infrastructure, such as is the case with YAML.

Infrastructure evolution method 200 then assembles the configuration blocks into the deployment specification 185 as a file (e.g., Terraform configuration file or Ansible playbook). The blocks are placed into the deployment specification 185 in a coherent order, that, when executed, will result in a compute infrastructure that conforms to the PIT graph. In one embodiment, related components are placed into the deployment specification file in positions that ensure dependencies are properly handled (e.g., ensuring subnetworks are defined before compute instances that used the subnetworks).

In one embodiment, to generate the configuration blocks, infrastructure evolution method 200 accesses and retrieves configuration templates or patterns of infrastructure code that correspond to the type of the components. Infrastructure evolution method 200 populates the configuration templates for the individual components of the PIT graph based on the specific attributes of the individual components to produce the configuration blocks for the individual components. For example, a number of CPUs, amount of memory, and disk size specified for an individual compute instance in the PIT graph would be used to populate the corresponding fields for the compute instance in the configuration block. The infrastructure modification method then inserts or adds the completed configuration blocks to the deployment specification. Once the components of the PIT graph are added to the deployment specification, the deployment specification is completed.

Infrastructure evolution method 200 then stores completed deployment specification is then stored for subsequent execution. For example, the finalized deployment specification is written to a file. The file may be, for example, a *.yml file for an Ansible YAML playbook, or a *.tf file for a Terraform HCL configuration file.

In one embodiment, the steps of block 225 are performed by specification generator 120. At the conclusion of block 225, infrastructure evolution method 200 has converted the modified infrastructure topology 180 into an executable deployment specification 185, which may be consumed by an orchestration engine 125 to automatically configure and deploy evolved compute infrastructure 190 according to the revised infrastructure requirements 170. Processing continues to block 230.

In one embodiment, prior to proceeding to deploy the evolved compute infrastructure 190 (as discussed in block 230 below), infrastructure evolution method 200 presents the proposed evolution of the infrastructure to a user or administrator for review. The proposed evolution may be presented in a user interface, such as a graphical user interface. In one embodiment, the changes with respect to the previous instance of the compute infrastructure are summarized. The summary may be generated by an LLM in response to a prompt. The prompt may provide both the infrastructure topology 165 and the modified infrastructure topology 180 to the LLM with instructions to summarize the differences. The prompt may also provide both the infrastructure requirements 155 and the revised infrastructure requirements 170. The response of the LLM is parsed to capture the summary. The infrastructure evolution method 200 presents the summary in the graphical user interface. The infrastructure evolution method 200 also presents a user-selectable option to accept the changes and proceed with evolution of the compute infrastructure 135. The infrastructure evolution method 200 also presents a user-selectable option to reject the changes and cancel evolution, thereby causing the prior instance of the compute infrastructure 135 to remain in place. The infrastructure evolution method 200 is configured to wait for and receive an indication that a user has selected one or the other of the user-selectable options. In one embodiment, the user-selectable options are graphical buttons. In one embodiment, the user-selectable options are presented textually in a command-line interface.

At block 230, infrastructure evolution method 200 executes the deployment specification 185 to install the evolved compute infrastructure 190 on the target computing system 130 to cause the parameter to cease to satisfy the condition. Infrastructure evolution method 200 operates the orchestration engine 125 as instructed by the deployment specification 185 to update the compute infrastructure 135 to a modified instance that corrects for the condition. The infrastructure evolution method 200 transitions the compute infrastructure 135 to new setup that brings the parameter(s) back into acceptable range(s).

In one embodiment, infrastructure evolution method 200 takes the deployment specification 185 as input; parses the deployment specification 185 to determine the declarations or sequence of actions for provisioning and configuring the evolved compute infrastructure 190 in the target computing system 130; executes the declarations or sequence of actions to provision and configure the evolved compute infrastructure 190 in the target computing system 130. The evolved compute infrastructure 190 is virtualized computer infrastructure that is fully-configured and operable in the in the target computer system 130. As deployed, the evolved computer infrastructure 190 matches the compute infrastructure specified in the revised infrastructure requirements 170. Infrastructure evolution method 200 thus uses the deployment specification 185 to automatically set up the target computer system 130 with an instance of compute infrastructure 135 that conforms to the revised infrastructure requirements 170.

Note that three different approaches to building the evolved compute infrastructure 190 in the target computer system 130 are possible:
1. Build the entire evolved compute infrastructure 190 in the target computer system 130 adjacent to (or in parallel with) the prior iteration of the compute infrastructure that is already in operation. Then, once the evolved compute infrastructure 190 is built, switch the compute infrastructure 135 from the prior iteration to the evolved iteration. This provides for easier migration/upgrade/switch to the new infrastructure and supports quick fallback to the prior iteration of the compute infrastructure should something go wrong.
2. Modify the prior iteration of the compute infrastructure 135 in place to match the evolved compute infrastructure 190. The build process may be shorter and simpler.
3. Hybrid approach, where some of the elements of the infrastructure are built in parallel to the running system with the intention to switch when the new elements of the infrastructure are ready for deployment, whereas other elements of the infrastructure are modified prior iteration to match the evolved compute infrastructure 190. The good example is the infrastructure where application layer is installed on the containerization platform with the backend database system.

In one embodiment, infrastructure evolution method 200 executes the deployment specification to install the evolved compute infrastructure on the target computing system to cause the parameter to cease to satisfy the condition as follows. Infrastructure evolution method 200 initializes an orchestration engine 125 for executing the deployment specification 185. For example, infrastructure evolution method 200 initializes IaC tools and establishes access to the target computing system 130. Infrastructure evolution method 200 accesses the deployment specification 185 (e.g., a YAML or HCL file) from its location in storage. Infrastructure evolution method 200 parses the deployment specification 185 to identify the infrastructure components (e.g., virtual machines, networks, storage, and security groups) that are to be provisioned and configured in the target computing system 130, and their inter-relationships.

Infrastructure evolution method 200 provisions an instance of compute infrastructure 135 in the target computing system 130 that places the infrastructure components in the target computing system 130 in accordance with their inter-relationships. For example, infrastructure evolution method 200 provisions components of the evolved computer infrastructure 190 in the target computing system 130, for example allocating resources (e.g., providing the specified CPU, RAM, and storage of a given virtual machine) and applying network settings and access controls. Once the components of the evolved compute infrastructure 190 are provisioned, infrastructure evolution method 200 applies additional configuration tasks (if any) that are specified in the deployment specification 185, such as installing software, setting up services, and configuring application settings on the evolved compute infrastructure 190.

Then, in one embodiment, infrastructure evolution method 200 grants a client network access to the instance of the evolved compute infrastructure 190 that is provisioned and configured in the target computing system 130. In one embodiment, infrastructure evolution method 200 returns one or more IP addresses, DNS names, and/or endpoint URLs for accessing the provisioned and configured instance of the evolved compute infrastructure 190. In one embodiment, infrastructure evolution method 200 redirects to the evolved compute infrastructure 190 those IP addresses, DNS names, and/or endpoint URLs that were previously assigned to a prior instance of the compute infrastructure, thereby improving the seamlessness of the transition from an existing instance of compute infrastructure 135 to an evolved, updated instance of the compute infrastructure 135.

In one embodiment, individual infrastructure components are directly addressable by IP address or DNS name. In one embodiment, discrete endpoint URLs are provided that are specific to particular services that are available in the provisioned and configured compute infrastructure, such as an endpoint for storage or for a database. In one embodiment, an API gateway provides a unified endpoint URL through which API requests are routed to services configured to handle the requests in the provisioned and configured compute infrastructure.

In one embodiment, the steps of block 230 are performed by orchestration engine 125. At the conclusion of block 230, infrastructure evolution method 200 has autonomously updated compute infrastructure 135 of a target computing system 130 so as to correct for operation that is defined as abnormal by one or more conditions. Processing continues to END block 235, where infrastructure evolution method 200 concludes.

At the conclusion of infrastructure evolution method 200, the compute infrastructure has self-evolved in response to one or more operational modes that are counter-indicated, such as overutilization, underutilization, or execution of outdated or un-patched software. This is a substantial improvement over existing processes for modifying compute infrastructure, which do not autonomously correct for proscribed modes of operation.

### Example Additional Features of Infrastructure Evolution Method

In one embodiment, the infrastructure evolution method 200 further includes steps to monitor the parameters continually and to perform the process to evolve the compute infrastructure on those occasions when a condition for evolution is detected. For example, the steps of infrastructure evolution method 200 may be performed in a loop that iterates each time the condition is detected until an instruction to terminate the monitoring is received. After an iteration of infrastructure evolution method 200, the method returns to monitoring the parameter until an instruction to terminate the monitoring is received. In this monitoring mode, the infrastructure evolution method 200 awaits parameter values that cause the Boolean expression for detection of the condition to evaluate to TRUE (or otherwise satisfy the condition). In response to a further detection of the condition, the infrastructure evolution method 200 repeats the steps of (1) revising the infrastructure requirements (discussed at block 215 above), (2) modifying the infrastructure topology (discussed at block 220 above), (3) converting the modified infrastructure topology into the deployment specification (discussed at block 225 above), and (4) executing the deployment specification to install the evolved compute infrastructure on the target computing system (discussed at block 230 above). At the conclusion of this further iteration of infrastructure evolution method 200, the infrastructure evolution method returns to the monitoring step (described above at block 210).

In one embodiment, the infrastructure evolution method 200 detects the condition because the compute infrastructure is overutilized or underutilized based on the parameter. Here, the parameter is or indicates a level of usage of the compute infrastructure. Then the infrastructure evolution method 200 uses the first LLM to revise the infrastructure requirements to adjust compute resources of the compute infrastructure.

In one embodiment, the infrastructure evolution method 200 autonomously adjusts the compute infrastructure to be leaner in terms of allocated resources in response to detection that the compute infrastructure is underutilized (e.g., is overbuilt or excessive for serving actual demands on the compute infrastructure). Such underutilization is wasteful of computing power, and infrastructure evolution method 200 improves the technology of cloud computing by automatically identifying opportunities to conserve computing resources and automatically reconfiguring the compute infrastructure so as to effect conservation of the resources. Therefore, infrastructure evolution method 200 may further detect the condition because the compute infrastructure is underutilized based on the parameter. Here, the parameter indicates a level of usage of the compute infrastructure. Infrastructure evolution method 200 then uses the requirements LLM to revise the infrastructure requirements to reduce compute resources of the compute infrastructure. From the revised infrastructure requirements, an updated configuration of the compute infrastructure is generated and deployed to the target system.

In one embodiment, the infrastructure evolution method 200 autonomously adjusts the compute infrastructure to be more substantial in terms of allocated resources in response to detection the infrastructure is overloaded (e.g., is underbuilt or insufficient for serving actual demands on the compute infrastructure). Such overloading is detrimental to performance of applications deployed in the compute infrastructure, and infrastructure evolution method 200 improves the technology of cloud computing by automatically identifying opportunities to increase performance of existing compute infrastructure and automatically reconfiguring the compute infrastructure so as to effect the increase in performance. Therefore, infrastructure evolution method 200 may further detect the condition because the compute infrastructure is overutilized based on the parameter. As above, the parameter indicates a level of usage of the compute infrastructure. Infrastructure evolution method 200 uses the requirements LLM to revise the infrastructure requirements to increase compute resources of the compute infrastructure. From the revised infrastructure requirements, an updated configuration of the compute infrastructure is generated and deployed to the target system.

In one embodiment, the infrastructure evolution method 200 evolves the compute infrastructure to include updated software for a component of the compute infrastructure. Therefore, infrastructure evolution method 200 may further detect the condition because an update to a component of the compute infrastructure has become available. And, infrastructure evolution method 200 then uses the requirements LLM to revise the infrastructure requirements to specify the component of the compute infrastructure to be configured according to the update. From the revised infrastructure requirements, an updated configuration of the compute infrastructure is generated and deployed to the target system.

Note that the ability to automatically upgrade a software component, e.g., operating system (OS), depends on upward compatibility of the software component being upgraded. If upward compatibility is not assured, actions need to be taken to compensate for this lack of upward compatibility, and human intervention may be required before the upgrade. E.g., upgrade of Python interpreter from 3.9 to 3.11 may result in a plethora of library function methods being deprecated in 3.11 and requiring a source code change for application programs written in Python.

In one embodiment, modification of the infrastructure topology is performed in two phases: (1) LLM modification of a logical infrastructure topology for the compute infrastructure (as currently configured) based on the revised infrastructure requirements; and (2) LLM modification of a physical infrastructure topology for the compute infrastructure (as currently configured) based on the revised infrastructure requirements and the modified logical infrastructure topology. Infrastructure evolution method 200 may therefore modify the infrastructure topology for the compute infrastructure to cause it to conform to the revised requirements using one or more additional LLM, such as a LIT modification LLM and a PIT modification LLM. Infrastructure evolution method 200 translates the revised infrastructure requirements into a current logical infrastructure topology using a LIT modification LLM (an LLM in addition to the requirements LLM). The LIT modification LLM is trained to generate graphs of logical infrastructure from the infrastructure requirements and a prior logical infrastructure topology. Then, the infrastructure evolution method 200 translates the revised infrastructure requirements and the current logical infrastructure topology into a physical infrastructure topology using a PIT modification LLM (an LLM in addition to the LIT modification and requirements LLMs). The PIT modification LLM is trained to generate graphs of physical infrastructure from infrastructure requirements, the current logical infrastructure topology, and a prior physical infrastructure topology. Here, the modified infrastructure topology is the current physical infrastructure topology. In other words, the resulting physical infrastructure topology is used as the modified infrastructure topology.

In one embodiment, infrastructure evolution method 200 generates the executable deployment specification in YAML code or HCL code. Thus, the executable deployment specification may be written in YAML code or HCL code.

In one embodiment, infrastructure evolution method 200 autonomously generates an initial compute infrastructure from the infrastructure requirements in an original or initial version. For example, prior to revising the infrastructure requirements, infrastructure evolution method 200 generates an initial logical infrastructure topology from the infrastructure requirements using a logical infrastructure topology generation LLM. The LIT generation LLM is configured to generate graphs of logical infrastructure from the infrastructure requirements. Then, infrastructure evolution method 200 generates the physical infrastructure topology using a physical infrastructure topology generation LLM. The PIT LLM is configured to generate graphs of physical infrastructure from the graphs of logical infrastructure and the infrastructure requirements.

### Discussion of Infrastructure Evolution

In one embodiment, the infrastructure evolution method 200 implements self-evolving compute infrastructure. Where an LLM has been trained to adjust (e.g., raise) infrastructure requirements, for example, based on a condition triggered by monitoring, news of a particular product or technology update, etc., the LLM can be used to generate a self-evolving infrastructure.

FIG. 3 illustrates one example embodiment of an infrastructure evolution process 300 that is associated with self-evolution of compute infrastructure using LLMs. Initially, an infrastructure instance (G0) 305 is created based on initial infrastructure requirements (R0) 310 using an LLM-based infrastructure production system and method (for example as described below under the heading “Example Infrastructure Production”). The infrastructure production method creates an initial infrastructure 315, producing a collection of artifacts for infrastructure instance (G0) 305, including a LIT, PIT, and deployment specification that correspond to the initial infrastructure requirements (R0) 310. Infrastructure evolution process 300 deploys 320 a current instance (Gn) 325 of computing infrastructure according to the deployment specification of the initial infrastructure instance (G0) 305. The current instance (Gn) 325 of the infrastructure is operated within the cloud. The infrastructure evolution process 300 monitors operation of the current instance (Gn) 325.

Infrastructure evolution process 300 monitors operation 330 of the current instance (Gn) 325. While operation of the current instance (Gn) 325 of the compute infrastructure is operating within normal (335: YES) or acceptable ranges (which are defined by the conditions or thresholds), the current instance (Gn) 325 continues operating, and continues monitoring of operation 330 associated with the current instance (Gn) 325. Monitoring of operation 330 may detect operation outside of the defined acceptable range (330: NO), for example where one or more of the conditions is detected. For example, monitoring of operation 330 may detect that the current instance (Gn) 325 is overutilized or underutilized 340. Monitoring of operation 330 may detect a severe and prolonged underutilization of resources within the operating current instance (Gn) 325 of the compute infrastructure. Monitoring of operation 330 a severe and prolonged overutilization of resources within the current instance (Gn) 325 of the compute infrastructure that is operating in the cloud. Thus, the monitoring of operation 330 detects an abnormal (335: NO) under/overutilization of resources within the current instance (Gn) 325 of the compute infrastructure that is operating in the cloud.

A requirements LLM 160 is trained or taught to formulate and update infrastructure requirements. In response to the detection of the overutilization or underutilization, the requirements LLM formulates 345 a change of requirements (infrastructure requirement set Rn+1 350) to compensate for the under/overutilization of resources.

The updated infrastructure requirements Rn+1 350 are then fed into an LLM-based infrastructure modification system and method (for example as described below under the heading “Example Infrastructure Modification”). From the updated infrastructure requirements Rn+1 350 and LIT and PIT for the current instance (Gn) 325 of the compute infrastructure, the infrastructure modification system produces an update 355 of the compute infrastructure Gn+1. The updated instance of the compute infrastructure Gn+1 is set to be the new current instance of the compute infrastructure Gn. The LIT, PIT, and deployment specification for the updated instance 360 are used to introduce the change of compute infrastructure instance. The newly adjusted infrastructure instance Gn is then deployed 320 and operated 325 in place of G0 (or Gn−1, in a general case).

The infrastructure instance Gn is monitored, for example by checking the values of telemetry parameters gathered from the infrastructure instance Gn, against the conditions. The infrastructure evolution process 300 may repeat should under/overutilization of resources (or other conditions) be detected during operation of Gn.

Similarly, other operational requirements may be changed as triggered by monitoring. Similarly, software patches/version updates may be performed automatically in response to news about availability of new patches/versions of software packaged/products.

### Example Infrastructure Production

FIG. 4 illustrates one embodiment of an infrastructure production method 400 that is associated with self-evolution of compute infrastructure using LLMs. As a general overview, the infrastructure production method 400 automatically generates an instance of compute infrastructure based on human language infrastructure requirements. The generation performs two phases of LLM generation of infrastructure topologies to produce a LIT describing an architecture for the compute infrastructure and a PIT describing a specific implementation for the compute infrastructure. Generation of the PIT is followed by conversion of the PIT into a deployment specification that is executable by an orchestration engine to deploy the compute instance (as discussed above with reference to blocks 225 and 230). Infrastructure production method 400 is performed for generation of an initial configuration of compute infrastructure, either where no prior instance of the compute infrastructure exists, or where substantive conformance with a prior instance of the compute infrastructure (except as indicated by changes to the infrastructure requirements) is not indicated. Thus, infrastructure production method 400 automatically creates compute infrastructure that is not evolved from a previous instance.

In one embodiment, infrastructure production method 400 initiates at START block 405 in response to the infrastructure evolution system 100 determining one or more of (1) that infrastructure evolution system 100 has received an instruction to configure a target computer system as described by provided infrastructure requirements; (2) that infrastructure evolution system 100 has received an instruction to generate an executable deployment specification from provided infrastructure requirements; (3) infrastructure evolution system 100 has received a set of infrastructure requirements for computing infrastructure that are in human language form or format; (4) that an instruction to perform infrastructure production method 400 has been received; (5) a user or administrator has initiated infrastructure production method 400; (6) it is currently a time at which infrastructure production method 400 is scheduled to be run; or (7) infrastructure production method 200 should commence in response to detection of some other condition.

In one embodiment, the infrastructure evolution system 100 may be further configured as an infrastructure production system by inclusion of modules or components configured to perform the steps of infrastructure production method 400. At start block 405, infrastructure evolution system 100 is configured to execute infrastructure production method 400, for example as described above with reference to START block 205.

At block 410, the infrastructure production method 400 accesses infrastructure requirements for compute infrastructure. The infrastructure requirements may be transmitted to the infrastructure production system, or retrieved by the infrastructure production system from a location in storage. The infrastructure requirements are in human language, and need not follow a particular structure.

At block 415, the infrastructure production method 200 translates the infrastructure requirements into a LIT using a LIT generation LLM. The LIT generation LLM is configured to interpret the infrastructure requirements to generate a LIT. The infrastructure production method 200 populates a template prompt that is configured to cause LIT generation with the infrastructure requirements to dynamically generate a prompt to the LIT generation LLM. The template prompt for LIT generation instructs the LIT generation LLM to generate a LIT that satisfies the infrastructure requirements as code in a graph representation language (GRL) (or other textual representation). For example, the template prompt for LIT generation may be something like “Generate a logical infrastructure topology graph in [GraphRepresentationLanguage] for the following infrastructure requirements: [InfrastructureRequirements].”

The infrastructure production method then submits the prompt to the LIT generation LLM. The LIT generation LLM analyzes the prompt, applying learned rules and patterns to create a LIT, writing GRL code to add nodes and connections to produce the LIT. The LIT generation LLM returns a response. The response of the LIT generation LLM to the prompt includes the LIT, written in the GRL. Infrastructure production method 200 parses the response to extract the LIT, and stores the LIT for subsequent processing.

The LIT generation LLM is one of the graph generation LLMs 175. The LIT generation LLM is trained on a training dataset that pairs example infrastructure requirements with a corresponding example LIT graph that expresses a system architecture for compute infrastructure that conforms to the example infrastructure requirements. The training adjusts parameters of the LIT generation LLM to minimize error or loss between LIT graphs generated by the LIT generation LLM for example infrastructure requirements and LIT graphs provided as the example corresponding to the infrastructure requirements.

At block 420, the infrastructure production method 200 enhances the LIT with further information from the infrastructure requirements to produce a PIT using a PIT generation LLM. The PIT generation LLM is configured to interpret (i) the infrastructure requirements and (ii) a LIT generated from the infrastructure requirements to generate a PIT. The infrastructure production method 200 populates a template prompt that is configured for PIT generation with the infrastructure requirements and the LIT to dynamically generate a prompt to the PIT generation LLM. The template prompt for PIT generation instructs the PIT generation LLM to generate a PIT that satisfies the infrastructure requirements and follows the logical structure of the LIT as code in the GRL. For example, the template prompt for PIT generation may be something like “Generate a physical infrastructure topology graph in [GraphRepresentationLanguage] for the following infrastructure requirements: [InfrastructureRequirements], based on the following logical infrastructure topology graph: [LogicalInfrastructureTopologyGraph].”

The infrastructure production method then submits the prompt to the PIT generation LLM. The PIT generation LLM analyzes the prompt, applying learned rules and patterns to determine where the logical architecture described in the LIT should be extended to express physical architecture of the compute infrastructure, and then adding, removing, or altering nodes and connections within the GRL code of the LIT to produce the PIT. The PIT generation LLM returns a response. The response of the PIT generation LLM to the prompt includes the PIT, written in the GRL. Infrastructure production method 200 parses the response to extract the PIT, and stores the PIT for subsequent processing.

The PIT generation LLM is one of the graph generation LLMs 175. The PIT generation LLM is trained on a training dataset that groups example infrastructure requirements with corresponding examples of (1) a LIT graph that expresses a system architecture for compute infrastructure that conforms to the example infrastructure requirements and (2) a PIT graph that expresses an implementation of the compute infrastructure that both conforms to the example infrastructure requirements and has the architecture expressed by the corresponding LIT graph. The training adjusts parameters of the PIT generation LLM to minimize error or loss between (1) PIT graphs generated by the PIT generation LLM from the example infrastructure requirements and example LIT graph and (2) PIT graphs provided as the example corresponding to the infrastructure requirements and example LIT graphs.

At END block 425, the generated PIT is returned for conversion to an executable deployment specification (as described at block 225) and subsequent deployment activity (as described at block 230) to create an instance of the compute infrastructure that is implemented as specified by the PIT.

### Example Infrastructure Modification

FIG. 5 illustrates one embodiment of an infrastructure modification method 500 that is associated with self-evolution of compute infrastructure using LLMs. As a general overview, the infrastructure modification method 500 automatically generates an evolved (updated) instance of compute infrastructure based on human language infrastructure requirements, as well as on a prior instance of the compute infrastructure. As with infrastructure production method 400 above, the generation performs two phases of LLM generation of infrastructure topologies to produce a LIT and PIT for the compute infrastructure, but in infrastructure modification method 500, the generation of the LIT and PIT for the evolved instance is constrained to mimic the LIT and PIT of the prior instance, except where changes are indicated by the new infrastructure requirements. As above, the resulting PIT is converted into a deployment specification that is executable by an orchestration engine to deploy the evolved compute instance (as discussed above with reference to blocks 225 and 230). Infrastructure modification method 500 is performed for generation of updated configurations of a compute infrastructure which substantively conform with a prior instance of the compute infrastructure, except as indicated by changes to the infrastructure requirements. Thus, infrastructure modification method 500 automatically creates compute infrastructure that is evolved (or changed, or updated) from a previous instance.

In one embodiment, the infrastructure evolution system 100 may be further configured as an infrastructure modification system by inclusion of modules or components configured to perform the steps of the infrastructure modification method 500. At start block 505, infrastructure evolution system 100 is configured to execute infrastructure modification method 500, for example as described above with reference to START block 205.

At block 510, the infrastructure modification method 500 accesses revised infrastructure requirements, a prior LIT, and a prior PIT for the compute infrastructure. The revised infrastructure requirements, prior LIT, and prior PIT may be transmitted to the infrastructure modification system, or retrieved by the infrastructure modification system from a location in storage. The revised infrastructure requirements are in human language.

At block 515, the infrastructure modification method 500 modifies the prior LIT to conform to the revised infrastructure requirements to generate a modified LIT using a LIT modification LLM. The LIT modification LLM is configured to alter the prior LIT to conform to the revised infrastructure requirements in a manner that (1) reproduce or preserve the portions of the prior LIT that are unaffected by the changes between the original and revised infrastructure requirements, while (2) updating portions of the prior LIT that are affected by the changes. Thus, infrastructure modification method 500 generates a modified LIT by having the LIT modification LLM apply changes indicated in the revised infrastructure requirements to the prior LIT. The LIT modification LLM operates to replicate stable areas of the prior LIT in the modified LIT and to produce new elements in the modified LIT for areas influenced by the revised infrastructure requirements.

The infrastructure modification method 500 populates a template prompt with the infrastructure requirements to dynamically generate a prompt to the LIT generation LLM. The template prompt is configured to cause an LLM to modify a provided LIT to conform with revised infrastructure requirements with a minimum of changes. (Note, as used herein with reference to describe extent of changes between iterations of an infrastructure topology, the terms “minimum,” “minimal,” “as few as possible,” and the like need not be a true minimum amount of change, but instead refer to amounts that approach or approximate the minimum, for example, within 10% of the true minimum.)

The template prompt for LIT modification instructs the LIT generation LLM to update a prior LIT so as to satisfy the infrastructure requirements with minimal changes, and to output the updated LIT as code in a graph representation language (GRL) (or other textual representation). For example, the template prompt for LIT modification may be something like
“Given the prior logical infrastructure topology graph and the revised infrastructure requirements below, generate a modified logical infrastructure graph in [Graph_Representation_Language] that conforms to the revised infrastructure requirements by making as few changes as possible to the prior logical infrastructure topology graph.
Prior logical infrastructure topology graph:
[Prior_LIT_Graph]
Revised infrastructure requirements:
[Revised_Infrastructure_Requirements]”
   The infrastructure modification method 500 then submits the prompt to the LIT generation LLM. The LIT generation LLM analyzes the prompt, applying learned rules and patterns to propose changes, and then adding, removing, or altering nodes and connections within the GRL code of the prior LIT to produce the modified LIT. The LIT generation LLM returns a response. The response of the LIT generation LLM to the prompt includes the modified LIT, written in the GRL. Infrastructure modification method 500 parses the response to extract the modified LIT returned by the LLM, and stores the modified LIT for subsequent processing.

The LIT modification LLM is one of the graph generation LLMs 175. The LIT modification LLM is trained on a training dataset that couples corresponding sets of (a) example revised infrastructure requirements, (b) example prior LIT that does not conform to the example revised infrastructure requirements in one or more ways, and (c) example modified LIT that is changed minimally with respect to the prior LIT in order to conform to the example revised infrastructure requirements. The training adjusts parameters of the LIT modification LLM to minimize error or loss between (1) modified LITs generated from the example prior LIT by the LIT modification LLM to conform to the example revised infrastructure requirements and (2) the example modified LITs provided as the example corresponding to the revised infrastructure requirements.

At block 520, the infrastructure modification method 500 modifies the prior PIT based on the modified LIT, prior PIT, and further information from the revised infrastructure requirements to produce a modified PIT using a PIT modification LLM. Similar to the LIT modification LLM discussed above, the PIT modification LLM is configured to alter the prior PIT to conform to the revised infrastructure requirements in a manner that (1) reproduces or preserves the portions of the prior PIT that are unaffected by the changes between the original and revised infrastructure requirements, and (2) updates portions of the prior PIT that are affected by the changes.

The infrastructure modification method 500 populates a template prompt with the infrastructure requirements to dynamically generate a prompt to the PIT generation LLM. The template prompt is configured to cause an LLM to modify a provided PIT to conform with revised infrastructure requirements in a manner that minimizes changes. The template prompt for PIT modification instructs the PIT generation LLM to update a prior PIT with minimal changes that are sufficient to satisfy the infrastructure requirements, and to output the updated PIT as code in a graph representation language (GRL) (or other textual representation). For example, the template prompt for PIT modification may be something like
“Given the prior physical infrastructure topology graph, modified logical infrastructure topology graph, and the revised infrastructure requirements below, generate a modified physical infrastructure graph in [Graph_Representation_Language] that conforms to both (1) the revised infrastructure requirements and (2) the architecture of the modified logical infrastructure topology graph by making as few changes as possible to the prior physical infrastructure topology graph.
Prior physical infrastructure topology graph:
[Prior_PIT_Graph]
Modified logical infrastructure topology graph:
[Modified_LIT_Graph]
Revised infrastructure requirements:
[Revised_Infrastructure_Requirements]”

The infrastructure modification method 500 then submits the prompt to the PIT generation LLM. The PIT generation LLM analyzes the prompt, applying learned rules and patterns to propose changes to the prior PIT, and then adding, removing, or altering nodes and connections within the GRL code of the prior PIT to produce the modified PIT. The PIT generation LLM returns a response. The response of the PIT generation LLM to the prompt includes the modified PIT, written in the GRL. Infrastructure modification method 500 parses the response to extract the modified PIT returned by the LLM, and stores the modified PIT for subsequent processing.

The PIT modification LLM is one of the graph generation LLMs 175. The PIT modification LLM is trained on a training dataset that groups example revised infrastructure requirements with corresponding examples of (1) a modified LIT graph that expresses a system architecture for compute infrastructure that conforms to the example revised infrastructure requirements and (2) a modified PIT graph that expresses an implementation of the compute infrastructure that both conforms to the example revised infrastructure requirements and has the architecture expressed by the corresponding modified LIT graph. The training adjusts parameters of the PIT modification LLM to minimize error or loss between (1) PIT graphs generated by the PIT modification LLM from the example revised infrastructure requirements and example modified LIT graph and (2) the example modified PIT graphs corresponding to the example revised infrastructure requirements and example modified LIT graphs.

At END block 525, the modified PIT is returned for conversion to an executable deployment specification (as described at block 225) and subsequent deployment activity (as described at block 230) to create an instance of the compute infrastructure that is implemented as specified by the PIT and that is evolved from the prior instance of the compute infrastructure.

### Telemetry

The telemetry system may be configured to collect, process, and analyze the performance and health of virtualized (e.g., cloud) resources and services. The telemetry system may monitor a wide variety of parameters. For example, the telemetry system may monitor performance metrics such as CPU utilization, memory usage, disk I/O, network traffic, and response times. And, the telemetry system may monitor logs of events within the target computing system, such as user actions, application behavior, system startups, system shutdowns, system errors, configuration changes, and security alerts. Also, the telemetry system may monitor the status of entities of the deployed compute infrastructure, for example tracking parameters health and availability of cloud services and infrastructure components like uptime data, error rates, and service-level agreement (SLA) compliance metrics. These and other metrics help identify performance bottlenecks and ensure that the compute infrastructure is an adequate (and non-excessive) provisioning for the actual usage.

Various telemetry systems may be used to read or otherwise obtain the values of the various parameters. The telemetry systems can include, but are not limited to, Amazon CloudWatch for Amazon Web Services, Microsoft Azure Monitor and Log Analytics for Microsoft Azure, Google Cloud Monitoring and Logging for the Google Cloud Platform, and Oracle Cloud Infrastructure Monitoring and Logging for Oracle Cloud Infrastructure.

### Cloud or Enterprise Embodiments

In one embodiment, the present system (such as infrastructure evolution system 100) is a computing/data processing system including a computing application or collection of distributed computing applications for access and use by other client computing devices that communicate with the present system over a network. The applications and computing system may be configured to operate with or be implemented as a cloud-based network computing system, an infrastructure-as-a-service (IAAS), platform-as-a-service (PAAS), or software-as-a-service (SAAS) architecture, or other type of networked computing solution. In one embodiment the present system provides at least one or more of the functions disclosed herein and a graphical user interface to access and operate the functions. In one embodiment, infrastructure evolution system 100 is a centralized server-side application that provides at least the functions disclosed herein and that is accessed by many users by way of computing devices/terminals communicating with the computers of infrastructure evolution system 100 (functioning as one or more servers) over a computer network. In one embodiment infrastructure evolution system 100 may be implemented by a server or other computing device configured with hardware and software to implement the functions and features described herein.

In one embodiment, the components of infrastructure evolution system 100 may be implemented as sets of one or more software modules executed by one or more computing devices specially configured for such execution. In one embodiment, the components of infrastructure evolution system 100 are implemented on one or more hardware computing devices or hosts interconnected by a data network. For example, the components of infrastructure evolution system 100 may be executed by network-connected computing devices of one or more computing hardware shapes, such as central processing unit (CPU) or general-purpose shapes, dense input/output (I/O) shapes, graphics processing unit (GPU) shapes, and high-performance computing (HPC) shapes.

In one embodiment, the components of infrastructure evolution system 100 intercommunicate by electronic messages or signals. These electronic messages or signals may be configured as calls to functions or procedures that access the features or data of the component, such as for example application programming interface (API) calls. In one embodiment, these electronic messages or signals are sent between hosts in a format compatible with transmission control protocol/internet protocol (TCP/IP) or other computer networking protocol. Components of infrastructure evolution system 100 may (i) generate or compose an electronic message or signal to issue a command or request to another component, (ii) transmit the message or signal to other components of infrastructure evolution system 100, (iii) parse the content of an electronic message or signal received to identify commands or requests that the component can perform, and (iv) in response to identifying the command or request, automatically perform or execute the command or request. The electronic messages or signals may include queries against databases. The queries may be composed and executed in query languages compatible with the database and executed in a runtime environment compatible with the query language.

In one embodiment, remote computing systems may access information or applications provided by infrastructure evolution system 100, for example through a web interface server. In one embodiment, the remote computing system may send requests to and receive responses from infrastructure evolution system 100. In one example, access to the information or applications may be effected through use of a web browser on a personal computer or mobile device. In one example, communications exchanged with infrastructure evolution system 100 may take the form of remote representational state transfer (REST) requests using JavaScript object notation (JSON) as the data interchange format for example, or simple object access protocol (SOAP) requests to and from XML servers. The REST or SOAP requests may include API calls to components of infrastructure evolution system 100.

### Software Module Embodiments

In general, software instructions are designed to be executed by one or more suitably programmed processors accessing memory. Software instructions may include, for example, computer-executable code and source code that may be compiled into computer-executable code. These software instructions may also include instructions written in an interpreted programming language, such as a scripting language. Such software instructions may be arranged into program modules with each such module performing a specific task, process, function, or operation. The entire set of modules may be controlled or coordinated in their operation by an operating system (OS) or other form of organizational platform.

In one embodiment, one or more of the components described herein are configured as modules stored in a non-transitory computer readable medium. The modules are configured with stored software instructions that when executed by at least a processor accessing memory or storage cause the computing device to perform the corresponding function(s) as described herein. In one embodiment, non-transitory computer-readable media may include stored thereon computer-executable instructions for performing the modules or the functions or logic described herein.

In one embodiment, infrastructure evolution systems and methods described herein may be implemented by using a computer program product, comprising computer program/instructions which, when executed by a processor, cause the processor to perform any of the methods described in the disclosure.

### Computing Device Embodiment

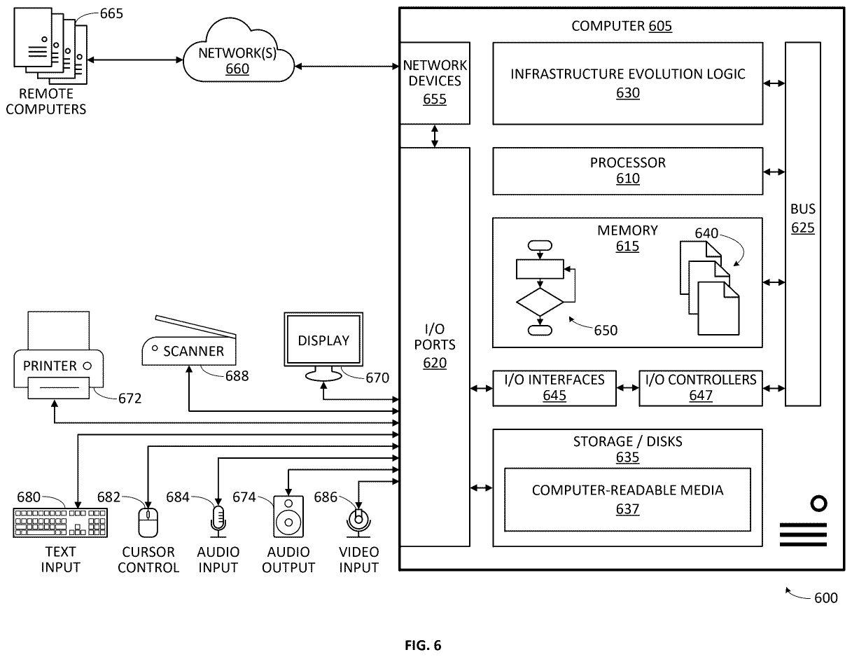

FIG. 6 illustrates an example computing system 600 that is configured and/or programmed as a special purpose computing device(s) with one or more of the example systems and methods described herein, and/or equivalents. The example computing device may be a computer 605 that includes at least one hardware processor 610, a memory 615, and input/output ports 620 operably connected by a bus 625. In one example, the computer 605 may include infrastructure evolution logic 630 configured to facilitate self-evolution of compute infrastructure using LLMs, similar to the logic, systems, methods, and other embodiments shown in and described with reference to FIGS. 1-5 .

In different examples, the logic 630 may be implemented in hardware, one or more non-transitory computer-readable media 637 with stored instructions, firmware, and/or combinations thereof. While the logic 630 is illustrated as a hardware component attached to the bus 625, it is to be appreciated that in other embodiments, the logic 630 could be implemented in the processor 610, stored in memory 615, or stored in disk 635.

In one embodiment, logic 630 or the computer is a means (e.g., structure: hardware, non-transitory computer-readable medium, firmware) for performing the actions described. In some embodiments, the computing device may be a server operating in a cloud computing system, a server configured in a Software as a Service (SaaS) architecture, a smart phone, laptop, tablet computing device, and so on.

The means may be implemented, for example, as an application-specific integrated circuit (ASIC) programmed to facilitate self-evolution of compute infrastructure using LLMs. The means may also be implemented as stored computer executable instructions that are presented to computer 605 as data 640 that are temporarily stored in memory 615 and then executed by processor 610.

Logic 630 may also provide means (e.g., hardware, non-transitory computer-readable medium that stores executable instructions, firmware) for performing one or more of the disclosed functions and/or combinations of the functions.

Generally describing an example configuration of the computer 605, the processor 610 may be a variety of various processors including dual microprocessor and other multi-processor architectures. A memory 615 may include volatile memory and/or non-volatile memory. Non-volatile memory may include, for example, read-only memory (ROM), programmable ROM (PROM), and so on. Volatile memory may include, for example, random access memory (RAM), static RAM (SRAM), dynamic RAM (DRAM), and so on.

A storage disk 635 may be operably connected to the computer 605 via, for example, an input/output (I/O) interface (e.g., card, device) 645 and an input/output port 620 that are controlled by at least an input/output (I/O) controller 647. The disk 635 may be, for example, a magnetic disk drive, a solid-state drive, a floppy disk drive, a tape drive, a Zip drive, a flash memory card, a memory stick, and so on. Furthermore, the disk 635 may be a compact disc ROM (CD-ROM) drive, a CD recordable (CD-R) drive, a CD rewritable (CD-RW) drive, a digital video disc ROM (DVD ROM) drive, and so on. The storage/disks thus may include one or more non-transitory computer-readable media. The memory 615 can store a process 650 and/or a data 640, for example. The disk 635 and/or the memory 615 can store an operating system that controls and allocates resources of the computer 605.

The computer 605 may interact with, control, and/or be controlled by input/output (I/O) devices via the input/output (I/O) controller 647, the I/O interfaces 645, and the input/output ports 620. Input/output devices may include, for example, one or more network devices 655, displays 670, printers 672 (such as inkjet, laser, or 3D printers), audio output devices 674 (such as speakers or headphones), text input devices 680 (such as keyboards), cursor control devices 682 for pointing and selection inputs (such as mice, trackballs, touch screens, joysticks, pointing sticks, electronic styluses, electronic pen tablets), audio input devices 684 (such as microphones or external audio players), video input devices 686 (such as video and still cameras, or external video players), image scanners 688, video cards (not shown), disks 635, and so on. The input/output ports 620 may include, for example, serial ports, parallel ports, and USB ports.

The computer 605 can operate in a network environment and thus may be connected to the network devices 655 via the I/O interfaces 645, and/or the I/O ports 620. Through the network devices 655, the computer 605 may interact with a network 660. Through the network 660, the computer 605 may be logically connected to remote computers 665. Networks with which the computer 605 may interact include, but are not limited to, a local area network (LAN), a wide area network (WAN), and other networks. Telemetry regarding the operation of a target computer system and/or compute infrastructure instance may be carried by network 660 from remote computers 665 configured as a cloud or virtualized computing system, such as the target computing system.

### Definitions and Other Embodiments

In another embodiment, the described methods and/or their equivalents may be implemented with computer executable instructions. Thus, in one embodiment, a non-transitory computer readable/storage medium is configured with stored computer executable instructions of an algorithm/executable application that when executed by a machine(s) cause the machine(s) (and/or associated components) to perform the method. Example machines include but are not limited to a processor, a computer, a server operating in a cloud computing system, a server configured in a Software as a Service (SaaS) architecture, a smart phone, and so on). In one embodiment, a computing device is implemented with one or more executable algorithms that are configured to perform any of the disclosed methods.

In one or more embodiments, the disclosed methods or their equivalents are performed by either: computer hardware configured to perform the method; or computer instructions embodied in a module stored in a non-transitory computer-readable medium where the instructions are configured as an executable algorithm configured to perform the method when executed by at least a processor of a computing device.

While for purposes of simplicity of explanation, the illustrated methodologies in the figures are shown and described as a series of blocks of an algorithm, it is to be appreciated that the methodologies are not limited by the order of the blocks. Some blocks can occur in different orders and/or concurrently with other blocks from that shown and described. Moreover, less than all the illustrated blocks may be used to implement an example methodology. Blocks may be combined or separated into multiple actions/components. Furthermore, additional and/or alternative methodologies can employ additional actions that are not illustrated in blocks. The methods described herein are limited to statutory subject matter under 35 U.S.C. § 101.

The following includes definitions of selected terms employed herein. The definitions include various examples and/or forms of components that fall within the scope of a term and that may be used for implementation. The examples are not intended to be limiting. Both singular and plural forms of terms may be within the definitions.

References to “one embodiment”, “an embodiment”, “one example”, “an example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in one embodiment” does not necessarily refer to the same embodiment, though it may.

A “data structure”, as used herein, is an organization of data in a computing system that is stored in a memory, a storage device, or other computerized system. A data structure may be any one of, for example, a data field, a data file, a data array, a data record, a database, a data table, a graph, a tree, a linked list, and so on. A data structure may be formed from and contain many other data structures (e.g., a database includes many data records). Other examples of data structures are possible as well, in accordance with other embodiments.

“Computer-readable medium” or “computer storage medium”, as used herein, refers to a non-transitory medium that stores instructions and/or data configured to perform one or more of the disclosed functions when executed. Data may function as instructions in some embodiments. A computer-readable medium may take forms, including, but not limited to, non-volatile media, and volatile media. Non-volatile media may include, for example, optical disks, magnetic disks, and so on. Volatile media may include, for example, semiconductor memories, dynamic memory, and so on. Common forms of a computer-readable medium may include, but are not limited to, a floppy disk, a flexible disk, a hard disk, a magnetic tape, other magnetic medium, an application specific integrated circuit (ASIC), a programmable logic device, a compact disk (CD), other optical medium, a random access memory (RAM), a read only memory (ROM), a memory chip or card, a memory stick, solid state storage device (SSD), flash drive, and other media from which a computer, a processor or other electronic device can function with. Each type of media, if selected for implementation in one embodiment, may include stored instructions of an algorithm configured to perform one or more of the disclosed and/or claimed functions. Computer-readable media described herein are limited to statutory subject matter under 35 U.S.C. § 101.

“Logic”, as used herein, represents a component that is implemented with computer or electrical hardware, a non-transitory medium with stored instructions of an executable application or program module, and/or combinations of these to perform any of the functions or actions as disclosed herein, and/or to cause a function or action from another logic, method, and/or system to be performed as disclosed herein. Equivalent logic may include firmware, a microprocessor programmed with an algorithm, a discrete logic (e.g., ASIC), at least one circuit, an analog circuit, a digital circuit, a programmed logic device, a memory device containing instructions of an algorithm, and so on, any of which may be configured to perform one or more of the disclosed functions. In one embodiment, logic may include one or more gates, combinations of gates, or other circuit components configured to perform one or more of the disclosed functions. Where multiple logics are described, it may be possible to incorporate the multiple logics into one logic. Similarly, where a single logic is described, it may be possible to distribute that single logic between multiple logics. In one embodiment, one or more of these logics are corresponding structure associated with performing the disclosed and/or claimed functions. Choice of which type of logic to implement may be based on desired system conditions or specifications. For example, if greater speed is a consideration, then hardware would be selected to implement functions. If a lower cost is a consideration, then stored instructions/executable application would be selected to implement the functions. Logic is limited to statutory subject matter under 35 U.S.C. § 101.

An “operable connection”, or a connection by which entities are “operably connected”, is one in which one or more communication channels are established (or may be established upon request) that allow signals, data messages, physical communications, and/or logical communications to be sent and/or received between the entities. An operable connection may include a physical interface, an electrical interface, and/or a data interface with one or more transmitters and receivers that communicate with wired and/or wireless signals. An operable connection may include differing combinations of interfaces and/or connections sufficient to establish and allow communication. For example, two entities can be operably connected to communicate signals to each other directly or through one or more intermediate entities (e.g., processor, operating system, logic, non-transitory computer-readable medium, internet communication devices, local network, etc.). Logical and/or physical communication channels can be used to create an operable connection.

“User”, as used herein, includes but is not limited to one or more persons, computers or other devices, or combinations of these.

While the disclosed embodiments have been illustrated and described in considerable detail, it is not the intention to restrict or in any way limit the scope of the appended claims to such detail. It is, of course, not possible to describe every conceivable combination of components or methodologies for purposes of describing the various aspects of the subject matter. Therefore, the disclosure is not limited to the specific details or the illustrative examples shown and described. Thus, this disclosure is intended to embrace alterations, modifications, and variations that fall within the scope of the appended claims, which satisfy the statutory subject matter requirements of 35 U.S.C. § 101.

To the extent that the term “includes” or “including” is employed in the detailed description or the claims, it is intended to be inclusive in a manner similar to the term “comprising” as that term is interpreted when employed as a transitional word in a claim.

To the extent that the term “or” is used in the detailed description or claims (e.g., A or B) it is intended to mean “A or B or both”. When the applicants intend to indicate “only A or B but not both” then the phrase “only A or B but not both” will be used. Thus, use of the term “or” herein is the inclusive, and not the exclusive use.

What is claimed is:

1. One or more non-transitory computer-readable media that include stored thereon computer-executable instructions that when executed by at least a processor of a computing system cause the computing system to:
monitor a parameter relating to a compute infrastructure that is deployed to a target computing system for a condition;
in response to detection of the condition, revise infrastructure requirements for the compute infrastructure to express an adaptation to the condition using a first LLM, wherein the infrastructure requirements are in human language;
modify an infrastructure topology for the compute infrastructure to conform to the revised infrastructure requirements using one or more additional LLMs;
convert the modified infrastructure topology into an executable deployment specification for evolved compute infrastructure that conforms to the revised infrastructure requirements; and
execute the deployment specification to install the evolved compute infrastructure on the target computing system to cause the parameter to cease to detect the condition.

2. The one or more non-transitory computer-readable media of claim 1, further comprising instructions that when executed by at least the processor cause the computing system to:
return to monitoring the parameter until an instruction to terminate the monitoring is received; and
in response to a further detection of the condition, repeat the steps of revising the infrastructure requirements, modifying the infrastructure topology, converting the modified infrastructure topology into the deployment specification, and executing the deployment specification to install the evolved compute infrastructure on the target computing system.

3. The one or more non-transitory computer-readable media of claim 1, further comprising instructions that when executed by at least the processor cause the computing system to:
detect the condition because the compute infrastructure is underutilized based on the parameter, wherein the parameter indicates a level of usage of the compute infrastructure; and
use the first LLM to revise the infrastructure requirements to reduce compute resources of the compute infrastructure.

4. The one or more non-transitory computer-readable media of claim 1, further comprising instructions that when executed by at least the processor cause the computing system to:
detect the condition because the compute infrastructure is overutilized based on the parameter, wherein the parameter indicates a level of usage of the compute infrastructure; and
use the first LLM to revise the infrastructure requirements to increase compute resources of the compute infrastructure.

5. The one or more non-transitory computer-readable media of claim 1, further comprising instructions that when executed by at least the processor cause the computing system to:
detect the condition because an update to a component of the compute infrastructure has become available; and
use the first LLM to revise the infrastructure requirements to specify the component of the compute infrastructure to be configured according to the update.

6. The one or more non-transitory computer-readable media of claim 1, wherein the computer-executable instructions to modify the infrastructure topology for the compute infrastructure to conform to the revised infrastructure requirements using the one or more additional LLMs, when executed by at least the processor, further cause the computing system to:
translate the revised infrastructure requirements into a current logical infrastructure topology using one of the additional LLMs that is trained to generate graphs of logical infrastructure from the infrastructure requirements and a prior logical infrastructure topology; and
translate the revised infrastructure requirements and the current logical infrastructure topology into a physical infrastructure topology using one of the additional LLMs that is trained to generate graphs of physical infrastructure from infrastructure requirements, the current logical infrastructure topology, and a prior physical infrastructure topology, wherein the physical infrastructure topology is used as the modified infrastructure topology.

7. The one or more non-transitory computer-readable media of claim 1, wherein the executable deployment specification is written in YAML code or HCL code.

8. A computer-implemented method, the method comprising:
monitoring a parameter relating to a compute infrastructure that is deployed to a target computing system for a condition;
in response to detection of the condition, revising infrastructure requirements for the compute infrastructure to express an adaptation to the condition using a first LLM, wherein the infrastructure requirements are in human language;
modifying an infrastructure topology for the compute infrastructure to conform to the revised infrastructure requirements using one or more additional LLMs;
converting the modified infrastructure topology into an executable deployment specification for evolved compute infrastructure that conforms to the revised infrastructure requirements; and
executing the deployment specification to install the evolved compute infrastructure on the target computing system to cause the parameter to cease to detect the condition.

9. The computer-implemented method of claim 8, further comprising performing the steps of claim 8 in a loop that iterates each time the condition is detected until an instruction to terminate the monitoring is received.

10. The computer-implemented method of claim 8, further comprising:
detecting the condition because the compute infrastructure is overutilized or underutilized based on the parameter, wherein the parameter is a level of usage of the compute infrastructure; and
using the first LLM to revise the infrastructure requirements to adjust compute resources of the compute infrastructure.

11. The computer-implemented method of claim 8, further comprising:
detecting the condition because an update to a component of the compute infrastructure has become available; and
using the first LLM to revise the infrastructure requirements to specify the component of the compute infrastructure to be configured according to the update.

12. The computer-implemented method of claim 8, wherein modifying the infrastructure topology for the compute infrastructure to conform to the revised infrastructure requirements using the one or more additional LLMs further comprises:
translating the revised infrastructure requirements into a current logical infrastructure topology using one of the additional LLMs that is trained to generate graphs of logical infrastructure from the infrastructure requirements and a prior logical infrastructure topology; and
translating the revised infrastructure requirements and the current logical infrastructure topology into a physical infrastructure topology using one of the additional LLMs that is trained to generate graphs of physical infrastructure from infrastructure requirements, the current logical infrastructure topology, and a prior physical infrastructure topology, wherein the modified infrastructure topology is the physical infrastructure topology.

13. The computer-implemented method of claim 8, further comprising generating the executable deployment specification in YAML code or HCL code.

14. A computing system, comprising:
at least one processor connected to at least one memory;
one or more non-transitory computer-readable media that include stored thereon computer-executable instructions that when executed by at least the processor accessing the memory cause the computing system to:
monitor a parameter relating to a compute infrastructure that is deployed to a target computing system for a condition;
in response to detection of the condition, revise infrastructure requirements for the compute infrastructure to express an adaptation to the condition using a first LLM, wherein the infrastructure requirements are in human language;
modify an infrastructure topology for the compute infrastructure to conform to the revised infrastructure requirements using one or more additional LLMs;
convert the modified infrastructure topology into an executable deployment specification for evolved compute infrastructure that conforms to the revised infrastructure requirements; and
execute the deployment specification to install the evolved compute infrastructure on the target computing system to cause the parameter to cease to detect the condition.

15. The computing system of claim 14, wherein the computer-executable instructions, when executed by at least the processor, further cause the computing system to perform the steps of claim 1 in a loop that iterates each time the condition is detected until an instruction to terminate the monitoring is received.

16. The computing system of claim 14, wherein the computer-executable instructions, when executed by at least the processor, further cause the computing system to:
detect the condition because the compute infrastructure is overutilized or underutilized based on the parameter, wherein the parameter is a level of usage of the compute infrastructure; and
use the first LLM to revise the infrastructure requirements to adjust compute resources of the compute infrastructure.

17. The computing system of claim 14, wherein the computer-executable instructions, when executed by at least the processor, further cause the computing system to:
detect the condition because an update to a component of the compute infrastructure has become available; and
use the first LLM to revise the infrastructure requirements to specify the component of the compute infrastructure to be configured according to the update.

18. The computing system of claim 14, wherein the computer-executable instructions, when executed by at least the processor, further cause the computing system to:
prior to revising the infrastructure requirements, generate an initial logical infrastructure topology from the infrastructure requirements using a logical infrastructure topology generation LLM that is configured to generate graphs of logical infrastructure from the infrastructure requirements; and
generate the infrastructure topology using a physical infrastructure topology generation LLM that is configured to generate graphs of physical infrastructure from graphs of logical infrastructure and the infrastructure requirements, wherein the infrastructure topology is a physical infrastructure topology.

19. The computing system of claim 14, wherein the computer-executable instructions to modify the infrastructure topology for the compute infrastructure to conform to the revised infrastructure requirements using the one or more additional LLMs, when executed by at least the processor, further cause the computing system to:
translate the revised infrastructure requirements into a current logical infrastructure topology using one of the additional LLMs that is trained to generate graphs of logical infrastructure from the infrastructure requirements and a prior logical infrastructure topology; and
translate the revised infrastructure requirements and the current logical infrastructure topology into a physical infrastructure topology using one of the additional LLMs that is trained to generate graphs of physical infrastructure from infrastructure requirements, the current logical infrastructure topology, and a prior physical infrastructure topology, wherein the modified infrastructure topology is a current physical infrastructure topology.

20. The computing system of claim 14, wherein the executable deployment specification is written in YAML code or HCL code.
